(19) United States
(12) Patent Application Publication
(10) Pub. No.: US 2012/0130854 A1
(43) Pub. Date: May 24, 2012

(54) AskMyEsq: Automated Business and Legal Advisory Providing Methodology

(76) Inventors: Samuel Alemu, Elgin, IL (US); Praveen Chakravarthy Medikundam, Elgin, IL (US)

(21) Appl. No.: 12/952,755

(22) Filed: Nov. 23, 2010

(51) Int. Cl. G06Q 10/00; G06Q 30/00

(52) U.S. Cl. 705/26.41; 705/311

(57) ABSTRACT

AskMyEsq is an automated business methodology that eliminates the need for front office and in-person advisory services in firms. AskMyEsq involves customers contacting attorneys directly via E-mail for advisory services, thus eliminating the cumbersome process of contacting the front office of the firm to schedule time to talk with an attorney and make a payment for the services. AskMyEsq helps faster and 24×7 reach out to attorneys. The system will help firms make attorneys accessible to customers at all times in an affordable way by eliminating the overheads of having the traditional front office. In AskMyEsq, attorneys directly receive advisory requests on-line from customers. Upon receipt of the request, attorneys analyze the request, give professional response, specify a fee and optionally reserve a time-slot. Customers will then be able to view the advisory given and/or confirm the time-slot for meeting by paying the designated fee on-line.

### FIELD OF THE INVENTION

The present invention generally relates to Customer handling in firms, and more particularly relates to an automated method of providing business and legal advisories to Customers and scheduling in-person/phone consultations without the need for a front office.

### BACKGROUND OF THE INVENTION

In a traditional set-up, a professional service firm is unquestionably required to have front-office and on-site staff professionals to handle Customers' requests. Taking example of medium-large sized firms, there would be continuous Customers' request of various types through telephone, e-mail, fax, web-forms, and even walk-ins. The front-office receives these requests and handles them accordingly. If the request is made though telephone, the front office will transfer the call to the qualified professional who will then consult the Customer about the request being made, the amount of service fee, the method of payment, a time slot to meet in-person etc. Similarly, the professional will personally deal with walk-in Customers.

On the other hand, if the request comes through email, fax or web forms then the front office will consolidate all these requests on paper or using spreadsheets. The qualified professional again goes through these requests one by one; calls back the Customer to ascertain the nature of the request, convey the fee details and then book a time-slot.

In both the cases, the Customer visits the firm at the designated hour, pays the fee and then ushered in to meet the professional for an advisory session. Once the advisory session is concluded, the front-office contacts the Customer again to get feedback over phone, email, fax or post/courier service. The feedback thus received is again manually consolidated for further analysis and possible improvement.

Obviously this process is time consuming, and sometimes very difficult to manage. Often, legal professionals and the staffs in the front office will be overwhelmed by the number of requests each day. Considering the busy schedule of legal professionals, the routine administrative tasks associated with each requests renders this conventional customer handling process unpractical thus greatly reducing efficiently and timely execution of tasks. In addition to this, staffing and maintaining a front office in any firm is challenging. In most cases, small firms or individuals cannot afford such an infrastructure, not to mention the difficulty of finding qualified staffs to fill in the front office. Hence, an automated system which alleviates firms from these routine administrative works becomes crucial.

AskMyEsq is an automated means of handling Customers' request without the routine administrative works associated with the conventional Customer handling process discussed above. It avoids the need for front office in firms since Customers and legal professionals will get in touch directly in a systematized way. Customers submit online requests for advisory services and/or preferred dates for meeting. The legal professional will directly receive such online requests. In response, the professional will specify the service fee, give the proper professional advice and/or specify a free time-slot to be blocked by the Customer. Up on Customer's successfully payment of the specified amount, the Customer will be able to view the advisory given by the professional and/or the corresponding professional's calendar will be updated to block the specified time slot. With the implementation of this invention, the time spent on manually handling such requests by front office and then by legal professionals is successfully avoided.

### BRIEF SUMMARY OF THE INVENTION

The general idea and object of the invention at hand is to ease the Customer handling process in firms. As discussed above under “Background of the Invention”, the conventional Customer handling process through front office is time consuming and difficult to manage. AskMyEsq is a software supported business methodology that eliminates the shortcomings of this conventional Customer handling process. In this new invention, Customer fills an online form accessible from web/mobile web with advisory requests and/or preferred dates for a meeting, which is then forwarded to the legal professional directly. The professional then analyzes the request, give a professional response, specifies a fee and optionally reserves a time slot with an expiry period. Customers will then be able to view the advisory given or confirm the time-slot for meeting by paying the designated fee on-line.

AskMyEsq has the following key advantages:
1. Customers will get swift professional service without the need for going through the bureaucratic and lengthy administrative procedures associated with the conventional Customer handling process in firms.
2. Manual consolidation of requests received through multiple channels can quickly prove to be quite difficult to handle and highly error prone. AskMyEsq automated method of handling Customers' request solves this problem since the legal professional directly handles the requests and payments all at once.
3. Professional Calendar management is quite unreliable and unproductive as there is no guarantee that the Customer turns up at the appointed hour. With the AskMyEsq, the specific date for meeting with the legal professional is set-up only after payment is successfully made by Customer.
4. Obviously, it may not always be necessary to schedule for in-person/phone consultations for every requests made by Customers. Considering the busy schedule of professionals, it is most of the time advisable to handle simple requests on-line with minimal time spent on the same. With AskMyEsq, the professional will have this authority and discretion. Depending upon the nature of the requests, the professional may give advisory to the requests on-line with designated payment for access to the same or may propose a free-time slot when in-person/phone consultation session is necessary.
5. The front-office comes in between the legal professional and the Customer as an additional bureaucratic layer, keeping the Customer at a distance. AskMyEsq avoids such unnecessary bureaucratic layer as the Customer and legal professional deal directly without the need for the intervention from the front office. This highly builds the business relationship trust and greatly increases the accessibility of the professional to Customers at any given time.
6. Firms will be relieved from setting-up elaborated front-office setup. This greatly assists firms of all sizes in cutting back costs, and in saving time and resources expended on staffing such front offices.

### DETAILED DESCRIPTION OF THE INVENTION

The present invention is an automated business method of handling Customers' requests by firms; more specifically, it is an automated method of providing business and legal advisory services and scheduling free-time slots for in-person/phone consultations, all without the need for an extra intervention from front office.

FIRST: Customers will fill out the on-line request form specifying their requests for advisory and/or in-person/phone consultation session. The on-line request for this purpose is available at the firm's official website at www.bizlegalservices.com. The on-line request so forwarded by Customers will automatically be directed to Attorneys in the firm.

SECOND: The Attorneys at the back-end will receive these Customers' request in e-mail and in the form of Mobile Text Messages (SMS). The Attorneys will then analyze the requests and do the following steps while replying to the requests:
1. As appropriate, in the body of the e-mail, give a professional advice and/or propose a free time-slot if the request is more proper to be handled through in-person/phone consultation;
2. Fix a service fee for the advice given and/or the time proposed for in-person/phone consultation and enter the amount of fee in the subject line of the e-mail along with name and E-mail Id of the Customer making the request; and
3. Forward the e-mail to advise@bizlegalservices.com.

THIRD: The system in the invention will read the advisory mail with address advise@bizlegalservices.com and automatically direct the same to the Customer making the request with customized message and further links and instructions. Accordingly, Customer will get an instant e-mail message and SMS alert.

FOURTH: The message so received by Customer will have a customized and personalized message from the firm and a link to engage the services of the firm. If Customer does not click on the link to further engage the firm's services, the link will expire. However, if Customer clicks on the link, an electronic service agreement will be displayed for further acceptance. Once Customer accepts the terms and conditions of the service agreement, a payment link in the form of Google Checkout will automatically be displayed where the Customer will be able to pay the designated amount of service fee.

FIFTH: Upon successful payment of the service fee by Customer, Customer will be able to view the legal advice given by the professional for the request and/or block the professional's calendar for in-person/phone consultation.

### DRAWINGS

Other features and advantages of the invention will become apparent from the following more detailed step by step description, taken in conjunction with the accompanying screen shots of the application, which illustrate the invention.

FIG. 1. Shows the main website of the www.bizlegalservices.com which is accessible to everyone over the internet. The “Contact” and “Contact Us” feature of the website allows Customers to place their request with the firm.

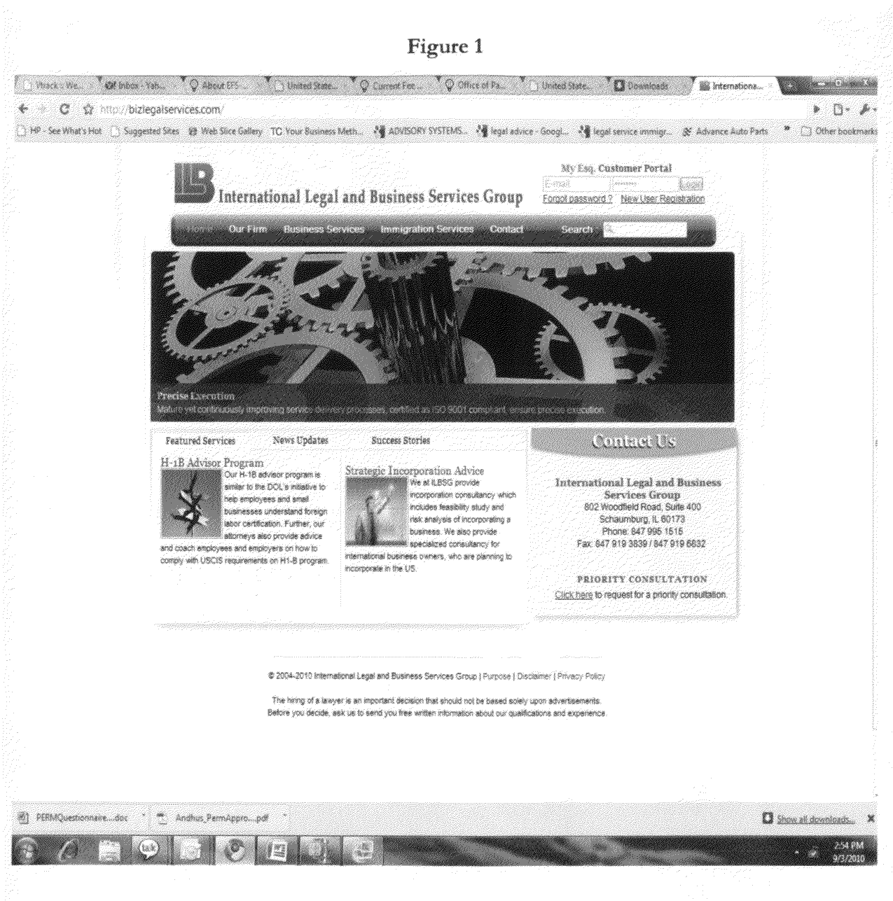

FIG. 2. Perspective illustration of the on-line form used by Customers to contact the firm by clicking on “Contact” or “Contact Us” button displayed in FIG. 1 above.

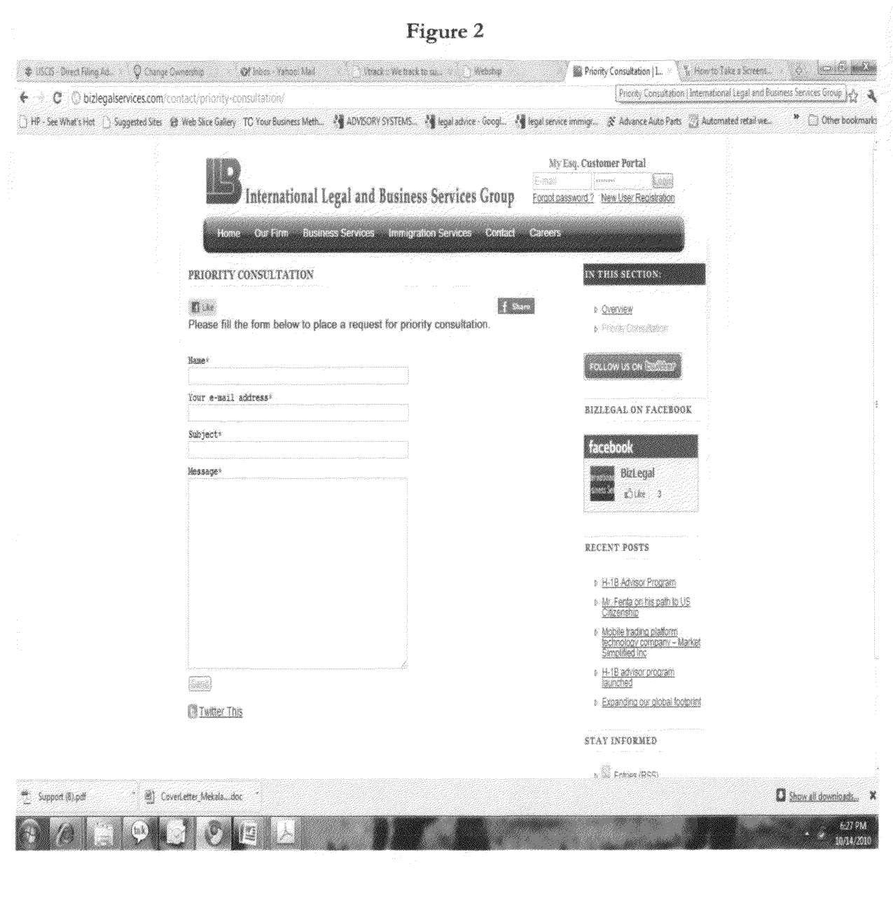

FIG. 3. Perspective illustration of the e-mail reply by the Attorneys to the requests placed by Customers. All Customers requests will be directed to Attorneys in the firm, and while replying, Attorneys will address the e-mail to advise@bizlegalservices.com, enter Customer's name, e-mail ID and the amount of service fee in the subject line of the e-mail. The figure also shows the body of the Attorneys's reply to Customer's request (a legal advice and/or a proposed time slot for in-person/phone consultation).

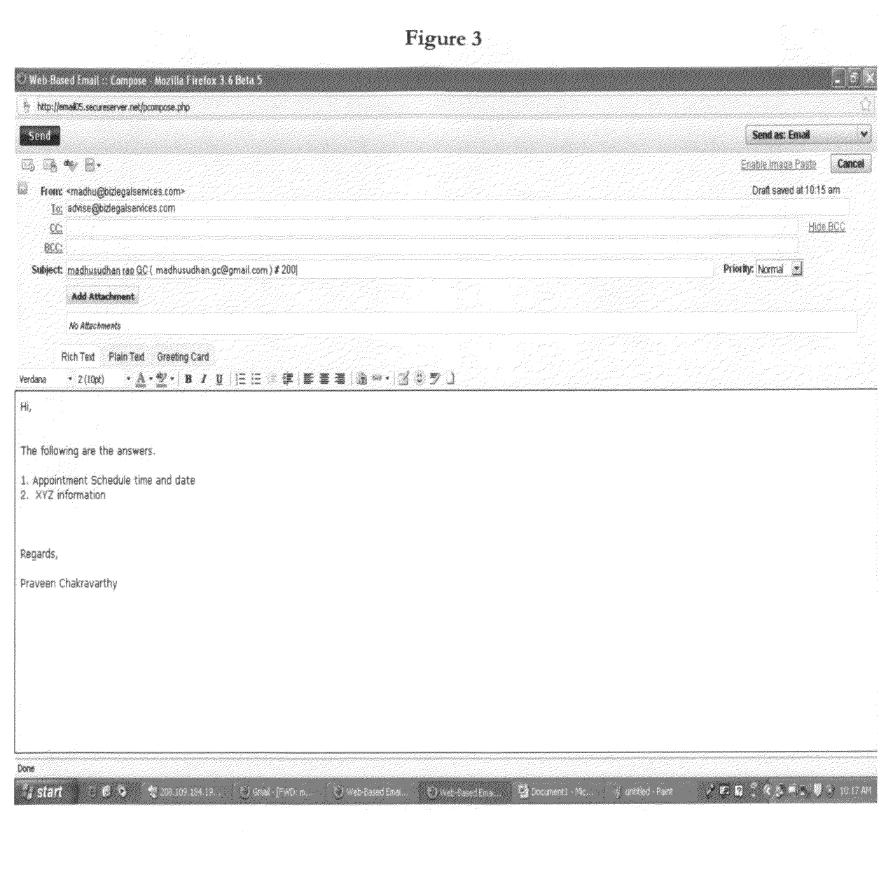

FIG. 4. Illustrates the e-mail that will be forwarded to Customer's following their request. The reply will consist of a personalized message addressing the Customer and gives information as to the Attorneys handling the case and provides the Customer with a link for further engaging the firm's services.

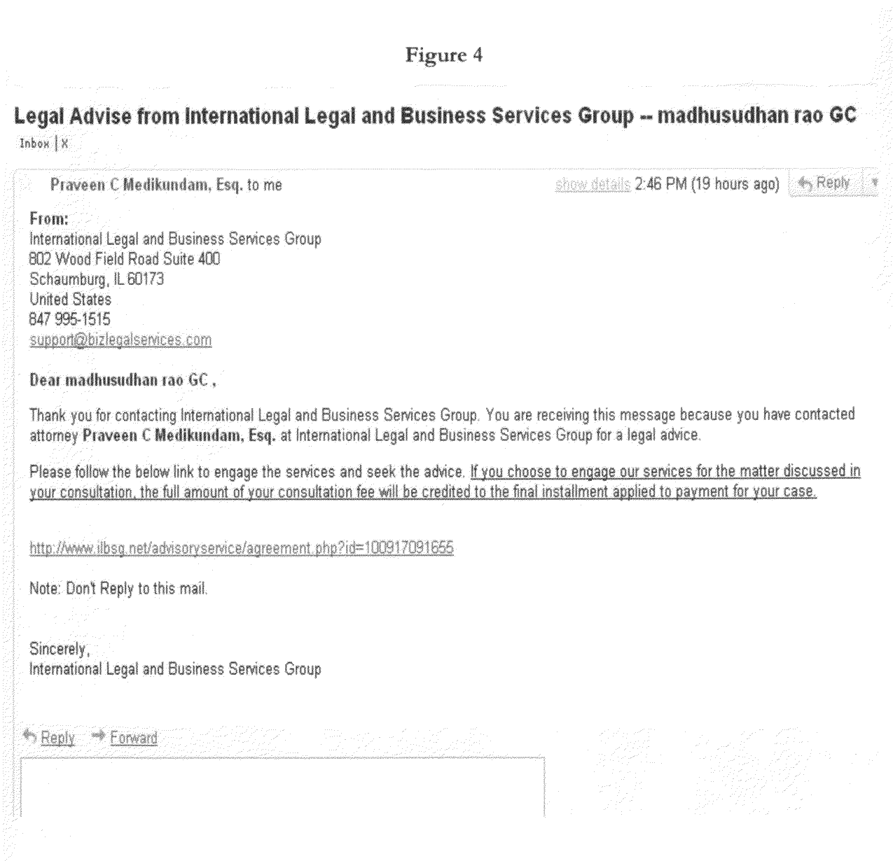

FIG. 5. Illustrates the message that will be displayed to Customers if they fail to click on the link provided (as illustrated in FIG. 4 above). The system will recognize the request as abandoned by Customer after the expiry of a certain period of time.

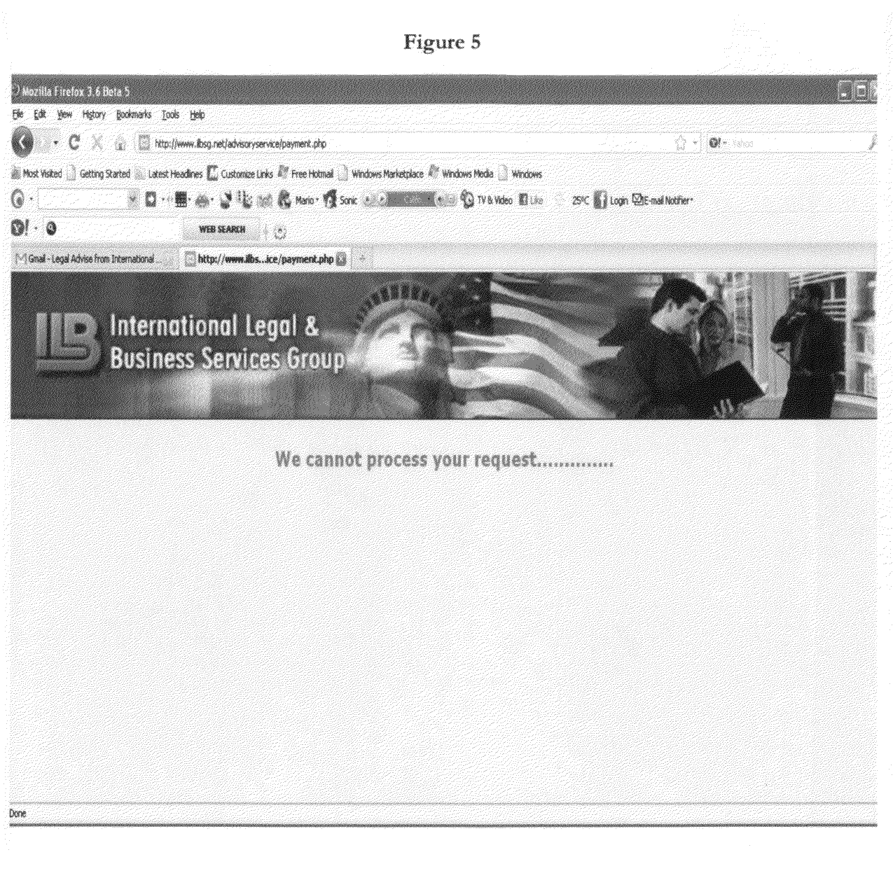

FIG. 6. Illustrates an Electronic Service Agreement of the firm that will be displayed to Customers upon clicking the link provided (as illustrated in FIG. 4 above). The Service Agreement embodies a detailed terms and conditions for Customer's review and acceptance.

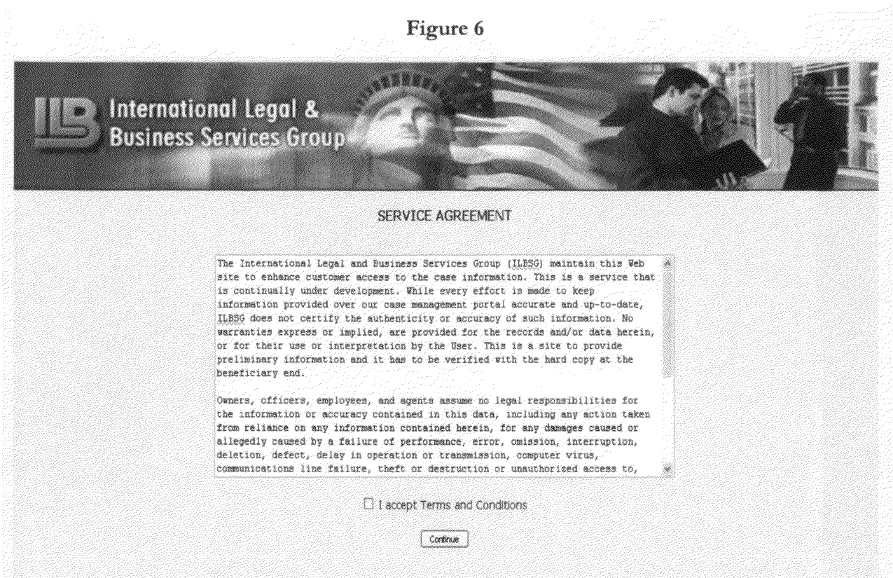

FIG. 7. Upon accepting the terms and conditions of the Electronic Service Agreement, Customers will be directed to Google Checkout link as illustrated.

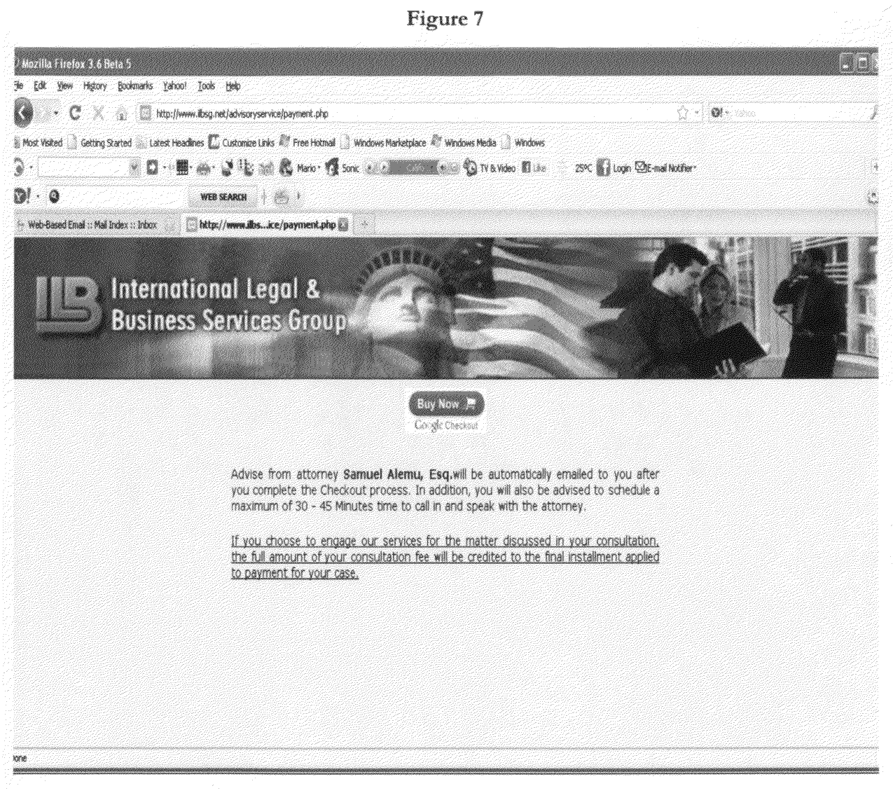

FIG. 8. Illustrates the detailed Google Checkout payment gateway enabling Customer to make payment of the designated service fee.

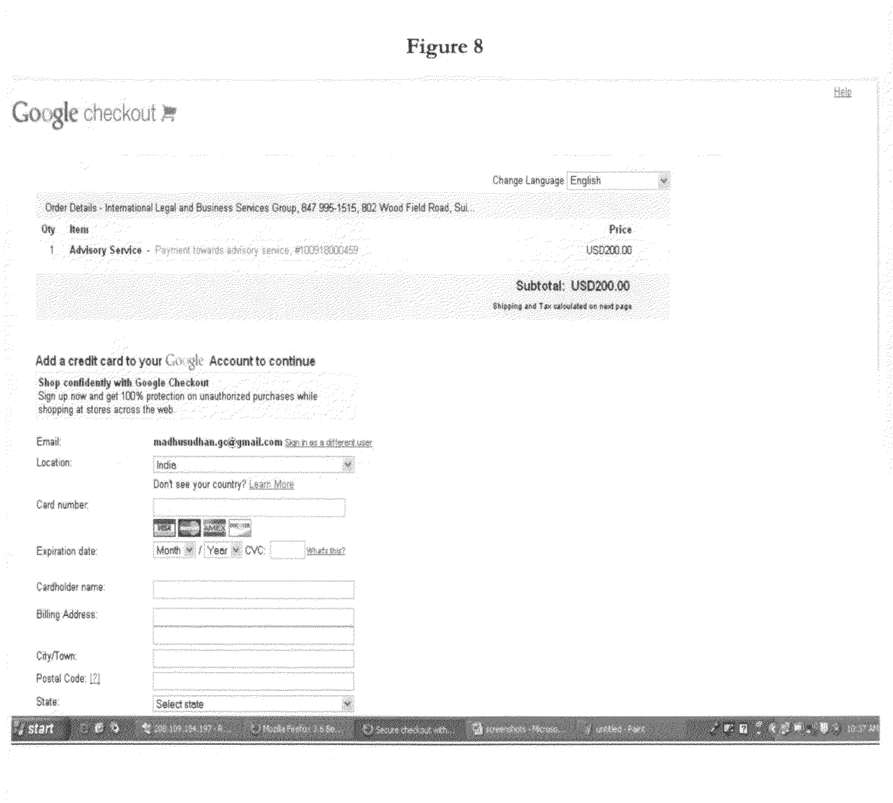

FIG. 9. Illustrates the final stage of the process whereby Customer who successfully made payment of the service fee is able to view the on-line advice given by the Attorney and/or block the Attorneys's calendar for the proposed time-slot for in-person/phone consultation.

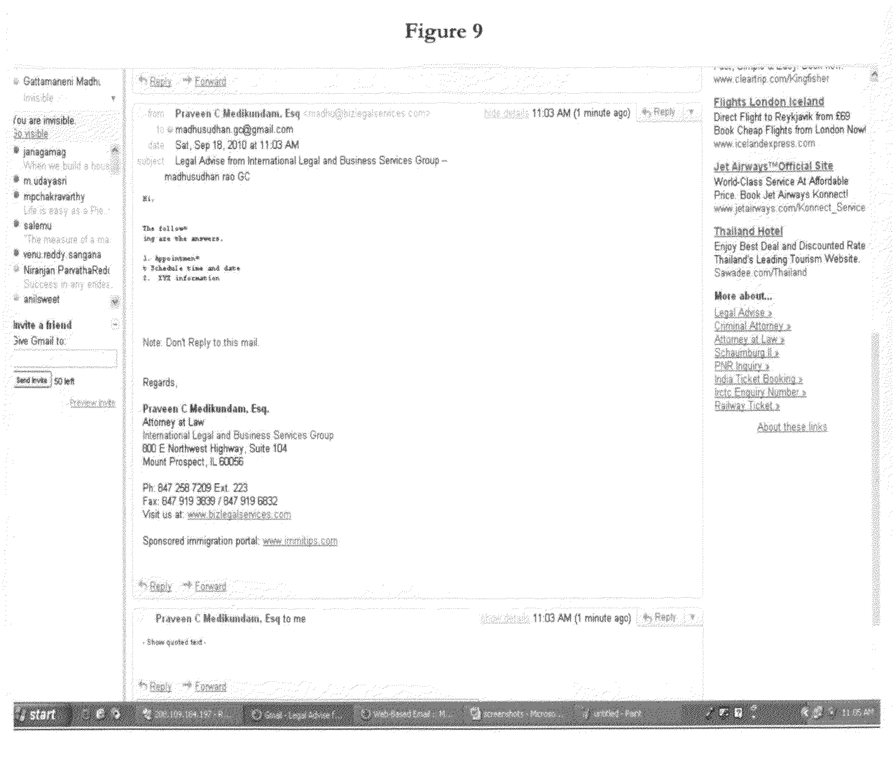

What is claimed is:

1. AskMyEsq business method system including: “Contact” and “Contact Us” feature available at www.bizlegalservices.com which allows Customers to place requests with a firm.

2. AskMyEsq business method system recited in claim 1 wherein Customers' e-mail requests is directly forwarded to Attorneys' within the firm.

3. AskMyEsq business method system recited in claim 2 wherein Attorneys' in the firm are able to reply to Customer's request though advise@bizlegalservices.com.

4. AskMyEsq business method system recited in claim 3 wherein the system recognizes Attorneys' e-mails and forwards the same to designated Customers with customized and personalized message.

5. AskMyEsq business method system recited in claim 4 wherein e-mail responses are sent to Customers with links to further engage the firm's services.

6. AskMyEsq business method system recited in claim 5 wherein Customer's are able to proceed with the link provided, pay the designated fee using Google Checkout payment gateway and be able to view Attorneys's advises and/or block Attorneys's calendars.
